(19) United States
(12) Patent Application Publication
(10) Pub. No.: US 2004/0236560 A1
(43) Pub. Date: Nov. 25, 2004

(54) Power estimation using functional verification

(76) Inventor: Thomas W. Chen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/445,138

(22) Filed: May 23, 2003

(51) Int. Cl. G06G 7/54; G06F 17/50

(52) U.S. Cl. 703/18; 716/4; 716/5

(57) ABSTRACT

An indication of power for one or more units of a circuit design are determined based on functional verification data. The functional verification data can be generated for input vectors applied to a representation of the circuit design to functionally verify operation of the design.

### TECHNICAL FIELD

The present invention relates to circuit analysis and, more particularly, to an approach to estimate power consumption using functional verification.

### BACKGROUND OF INVENTION

Power consumption is becoming an increasing concern in the design of integrated circuits (ICs), particularly for very large scale integration (VLSI) chip design. To address this concern, many computer-aided design (CAD) tools have been developed to measure or estimate power consumption in VLSI designs. The estimated power consumption is employed to help designers meet target power parameters and ultimately facilitate design convergence.

Techniques used to estimate switching activities associated with power consumption in VLSI chip designs can be divided into two general groups: simulation-based techniques and statistics-based techniques. For both types of techniques, the dynamic power consumption of a circuit is computed based on estimated switching activities of a circuit or a defined part of a circuit. In particular, power consumption is proportional to the switching activities and the associated capacitance at respective nodes of the circuit.

For power estimation, existing simulation-based approaches tend to be highly dependent on the input patterns (or input vectors) used to stimulate the circuit model. That is, the power estimation tool usually requires input patterns designed specifically for power estimation. Additionally, specialized power estimation simulations or CAD tools are often utilized to estimate power consumption.

Statistics-based approaches to power estimation can often achieve improved performance over simulation-based approaches because statistical inference can be performed based on a smaller amount of simulation data. Thus, statistics-based techniques can circumvent the need for prohibitively expensive simulations to cover a large input space in the simulation based techniques. However, most statistics based techniques may not be as accurate as actual simulations due to their inability to consider certain types of power consumption associated, such as associated with structural and operating glitches that may occur during actual simulation. Additionally, most existing statistical techniques treat average and maximum power estimation differently, which often requires separate tools for each of them. Furthermore, as with actual simulations, the choice of input vectors used for statistical inference is important for estimation accuracy. Accordingly, many statistical power estimation techniques tend to focus on deriving valid input patterns to improve the accuracy of the power estimation.

Some existing low-level power estimation tools (e.g., gate-level or circuit-level design tools) may require the user to make detailed architectural and technology implementation choices early in the design process. Power estimation at such a low level of design tends to impose inefficiencies in the design process since design changes will require additional power consumption determinations. Design changes can arise, for example, if the power consumption estimate exceeds the desired level or if the designer seeks to further refine the design for other reasons. Because of inflexibilities in many low-level power estimation approaches, more recent efforts have focused on employing higher-level circuit descriptions, such as Register Transfer Level descriptions. These approaches, however, still usually require complicated input patterns designed specifically for power estimation.

### SUMMARY OF INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some general concepts of the invention in a simplified form as a prelude to the more detailed description that is presented later.

The present invention relates generally to a system and method to estimate power consumption. One aspect of the present invention provides a system that employs functional verification data corresponding to functional behavior of at least one unit of a circuit design according to a testcase having a plurality of input vectors. The unit, for example, can be a node, a circuit component, a functional or structural block or a combination thereof. A power estimator that determines an indication of power for the at least one unit of the circuit design based on the functional verification data generated over a plurality of testcases. Using data from functional verification for power estimation allows power estimation to be carried out early in the design cycle. The availability of power consumption early in the design cycle can have significant benefits to overall design convergence in the area of reliability, overall design planning and/or packaging planning.

Another aspect of the present invention relates to a power estimation system that includes a model that estimates one or more power-related parameters based on data generated by performing functional verification over a plurality of testcases. A power calculator can compute estimated power based on the parameter estimated by the model.

Yet another aspect of the present invention provides a method for estimating power for a circuit design. The method includes accessing functional verification data generated for the circuit design based on one or more sets of input vectors, each set defining a testcase. An indication of power for the circuit is estimated based on the functional verification data generated over a plurality of testcases. The method, for example, can be implemented in hardware, software or a combination thereof.

Using data from functional verification for power estimation allows power estimation to be carried out early in the design cycle. The availability of power consumption information early in the design cycle can have significant benefits to overall design convergence in the area of reliability, overall design planning, and packaging planning.

### BRIEF DESCRIPTION OF THE DRAWINGS

FIG. 1 depicts a simplified block diagram of a power estimation system implemented in accordance with an aspect of the present invention.

FIG. 2 depicts an example of a power estimation system implemented in accordance with an aspect of the present invention.

FIG. 3 depicts an example of a simulation system that can be utilized to generate functional verification data for power estimation in accordance with an aspect of the present invention.

FIG. 4 depicts a statistical approach that can be implemented to estimate power in accordance with an aspect of the present invention.

FIG. 5 is a graph of illustrating simple average power estimated for a plurality of sample testcases.

FIG. 6 is a graph of illustrating moving average power estimated for a plurality of sample testcases.

FIG. 7 depicts a Bayesian approach that can be implemented to estimate power in accordance with an aspect of the present invention.

FIG. 8 is a graph of illustrating mean power estimated for a plurality of samples.

FIG. 9 is a graph illustrating standard deviation for power estimated for a plurality of samples.

FIG. 10 is a graph of illustrating mean power estimated for a plurality of samples having a reduced data set.

FIG. 11 is a graph illustrating standard deviation for power estimated for a plurality of samples having a reduced data set.

FIG. 12 depicts a power estimation system for plural circuit blocks implemented in accordance with an aspect of the present invention.

FIG. 13 is a flow diagram illustrating a methodology for estimating power in accordance with an aspect of the present invention.

### DETAILED DESCRIPTION

The present invention relates generally to a system and method that can be utilized to estimate power (e.g., associated with a circuit design). The estimated power, which can include average power and/or maximum power, can be estimated for one or more units. For example, in a circuit design, a given unit can correspond to a node or other juncture between adjacent components, structures or blocks, as well as a circuit component, a functional or structural block, or any combination thereof. Power is estimated for a given unit of the design based on functional verification data generated for at least the given unit over plural testcases.

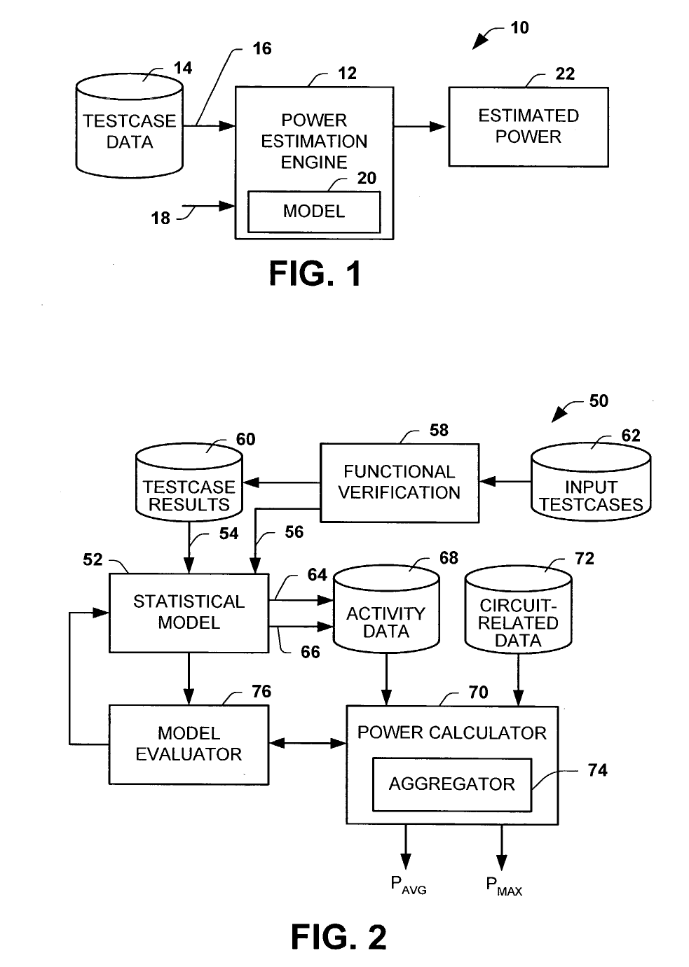

FIG. 1 illustrates a system 10 that can be implemented to estimate power in accordance with an aspect of the present invention. The system 10 includes a power estimation engine 12 that performs power estimation based on functional verification testcase data 14, corresponding to simulation results for one or more testcases. Each testcase is a collection of input patterns or vectors designed to functionally verify a particular portion or unit of a circuit design. At least a portion of the testcase data 14 provides information 16 associated with power consumption of the circuit design or a portion thereof (referred to herein as “power-related information”). The power estimation engine 12 performs the power estimation based on the power-related information 16 generated over a plurality of testcases.

It is desirable to estimate power consumption early in the design flow to facilitate meeting target power parameters and to facilitate design convergence. Some of the simulation data from functional verification are typically available even before the physical design phase has started, allowing power estimation to be performed early enough to better guide the physical design phase. The testcase data 14 can be generated by performing functional verification on a circuit model that represents the circuit design. The circuit model can be a register transfer level (RTL) description of an integrated circuit or chip; although, other high-level or low-level (e.g., transistor-level or gate-level) descriptions also could be utilized for functional verification. A higher level model, such as a RTL model utilized for functional verification simulation, generally can implement simulations more rapidly than lower-level simulations for the same circuit design.

Various commercially available CAD tools (e.g., available from Synopsis, Avant, Cadence or others) as well as proprietary tools can be employed to obtain the corresponding power-related information 16 from functional verification. These tools employ input patterns or vectors to functionally simulate and verify the correctness (or detect functional design flaws) of the circuit design. Such functional verification is routinely implemented on various types of integrated circuits to confirm expected performance prior to mass production. For example, greater than 50% of the design cycle can be consumed by functional verification, resulting in an abundance of data that can be used for power estimation implemented according to an aspect of the present invention. Examples of circuits functionally tested in this manner include processors (e.g., central processing unit (CPU) chips and microprocessors), application specific integrated circuits (ASICs), or other similarly complicated VLSI (Very Large Scale Integration).

Functional verification can provide various types of information indicative of operating behavior characteristics associated with the circuit design. One subset of functional verification corresponds to the power-related information 16, such as information that characterizes switching characteristics of respective units of the circuit design for a given testcase. For example, functional verification can provide an activity factor for nodes or junctures located between functional or structural blocks in the circuit model. The activity factor corresponds to a toggle count of switching activity for a node normalized over a number of clock cycles. The power-related information 16 can be obtained from memory, such as stored as an associated database or other data structure, as depicted in FIG. 1. Alternatively, power-related information, indicated at 18, can be provided to the power estimation engine 12 during the simulation process, such that the simulation and power estimation can occur concurrently in parallel. For purposes of clarity, the following discussion will refer to the power-related information using reference number 16, although it is to be understood that the information could include the information 16, 18 or both.

The power estimation engine 12 includes a model 20 that is updated based on the information 16 provided for a plurality of testcases. The power estimation engine 12 can update the model 20 over a predetermined number of testcases. Alternatively, the model 20 can be updated for a set of N testcases, where N is a positive integer sufficient to cause the estimated model parameters to converge to within an acceptable level. The value of N can be predefined or it can be variable, with the convergence of the model being evaluated, for example, by fitting the estimates relative to an asymptotic curve taken as N approaches infinity (e.g., by applying least square estimates or regression analysis).

As mentioned above, the model 20 is designed to determine the estimated power 22 based on the power-related information 16 generated by functional verification. For example, where the circuit design is represented to include a plurality of nodes or other structural junctures between associated structural or functional blocks, the model 20 parameterizes behavioral operating characteristics (e.g., the activity factor) for respective nodes in the design. The model 20 updates its estimate based on the power-related information over a plurality of testcases. By employing appropriate statistical methods, the model 20 can accurately estimate the operating characteristics based on the power-related information 16 to enable substantially accurate-power estimation for the design or a portion of the design. For example, the model 20 can be implemented using moving average statistics or a Bayesian model, which can be designed to parameterize power-related activity for respective parts (e.g., nodes) of the circuit design.

Additionally, the model 20 can be implemented by certain statistical methods (e.g., Bayesian) to facilitate a determination of both average and maximum power (corresponding to the estimated power 22) based on parameters estimated by the model. Advantageously, the model 20 can estimate the parameters based on common functional verification data generated over a plurality of testcases, such that separate sets of vectors generated specifically for power profile are not required for determining the average and maximum power. In particular, the model 20 provides mean and standard deviation estimates for unit-level (e.g., node-level) power-related operating characteristics. The power estimation engine 12 employs the updated unit-level mean and standard deviation estimates to compute corresponding unit-level mean and standard deviation power estimates. The power estimation engine 12 aggregates the respective unit-level mean power estimates to provide a total average power estimate. The engine 12 also aggregates the unit-level estimated standard deviations to provide a total estimated standard deviation. The total standard deviation estimate can then be added to the total average power estimate to provide a corresponding total maximum power estimate.

FIG. 2 is an example of a power estimation system 50 that can be implemented in accordance with an aspect of the present invention. The system 50 includes a statistical model 52 that is programmed and/or configured to estimate signal switching activities related to power consumption. The model 52 estimates the switching activities based on the power-related information 54 or 56 generated by functional verification 58.

The statistical model 52 can employ a variety of different statistical methods operative to estimate or predict signal switching activities based on the testcases implemented by the functional verification 58. For example, the statistical model 52 can be implemented as a Bayesian model, by moving average statistics, Monte Carlo analysis or by other methods. It is to be appreciated that these and other statistical approaches provide methods that can be employed to represent beliefs about power-related circuit characteristics, which are not certain (or uncertain), but for which there may be some supporting evidence. In the context of power estimation implemented in the example of FIG. 2, the supporting evidence includes the power-related information 54, 56 provided by the functional verification 58.

As mentioned above, the functional verification 58 is utilized to generate testcase results 60 indicative of behavior and/or structural operating characteristics associated with the circuit design for which the functional verification is being implemented. For example, the testcase results 60 can include information indicative of node-level switching activities for the circuit design, such as can be derived as the activity factor for corresponding nodes. The functional verification 58 can provide the testcase data for storage in suitable memory for use by the model 52 (via information 54) as well as by other CAD tools. Alternatively, as indicated at 56, the functional verification 58 can provide at least power-related information directly to the model 52, such as including the activity factor for respective nodes in the circuit design. It is to be appreciated that the testcase results 60 and/or the functional verification 58 can be generated remotely and obtained by the model 52 over a network or other type of communications link.

In accordance with an aspect of the present invention, the functional verification 58 corresponds to functional verification implemented on input testcases 62 designed to verify functional operation of the circuit design or a specific unit of the design, and not specifically developed for power estimation purposes. As mentioned above, such functional verification is routinely implemented during the design process of integrated circuits, including microprocessors and application specific integrated circuits (ASICs). As a result, additional efficiencies can be realized by the system 50 utilizing the testcase results 60 generated by functional verification 58 that is already being implemented, such that neither additional power simulations nor specialized input vectors are required. That is, the functional verification 58 can serve a dual purpose, namely, (1) functionally verifying a circuit design and (2) power estimation implemented according to an aspect of the present invention.

The statistical model 52 estimates switching activity characteristics for the circuit design. In the example of FIG. 2, the statistical model 52 provides a pair of estimated parameters based on the functional verification information 54 or 56. These parameters correspond to the mean associated with the power-related information, indicated at 64, and a standard deviation associated with such information, indicated at 66. The estimated mean and standard deviation values 64 and 66 for the entire circuit design (or a defined portion thereof) are collectively represented as activity data 68. Thus, by way of example, the activity data 68 includes mean and standard deviation estimates for the activity factors of the respective nodes in the circuit design based on the functional verification 58 implemented over the plurality of testcases 62.

The model 52 can be initialized, for example, by a random initial guess or, alternatively, the initial guess can be manually selected, such as based on expert or empirical studies. The statistical model 52 can update the estimated mean and standard deviation parameters 64 and 66 that form the activity data 68 based on the information 54, 56 generated for each respective testcase. As functional verification is performed on further testcases 62, more accurate estimations can be obtained for the mean and standard deviation estimates according to the statistical technique being implemented. As the number of testcases is taken to infinity, the estimated mean value will eventually converge or saturate to a given level, namely, the statistical mean.

The power estimation system 50 also includes a power calculator 70 operative to compute estimated average power P_{AVG} based on the activity data 68 and other circuit-related data 72. The circuit-related data 72 includes additional information such as, for example, signal nodes' load capacitance, circuit's operating voltage, and circuit's operating clock frequency.

The dynamic power consumption of a circuit is known to be proportional to the switching activities of signals in the circuit and the associated capacitance at those signal nodes. For example, the mean estimates 64 correspond to node-level switching activities, such as the node-level activity factor (AF), which estimates have associated standard deviation estimates 66. The circuit-related data 72 includes a load capacitance (C_{LOAD}), chip supply voltage (V_{DD}), and chip clock frequency (f_{clk}) for each respective node in the corresponding circuit design. It is to be appreciated that V_{DD} and f_{clk}are typically fixed for a given chip and that C_{LOAD} can be readily determined from the RTL or other level description of the circuit design. Thus, the power (P) computed by the power calculator 70 can be computed for each node as follows:

P=AF*V_{DD}²*C_{LOAD}*f_{CLK} Eq. 1

The power calculator 70 also can include an aggregator 74. The aggregator 74 is operative to aggregate or sum the respective computed power calculations to provide a total estimated average power P_{AVG}. Additionally, the power calculator 70 can employ the aggregator 74 to sum the estimated standard deviations for the estimated power to provide a total standard deviation for the estimated average power. Maximum power P_{MAX} can be computed as a function of the total estimated average power P_{AVG} and the total standard deviation power. A total standard deviation power, which is proportional to the total one-sigma standard deviation power (e.g., a one-sigma or higher standard deviation power), can be computed according to the desired confidence level. For example, a three-sigma standard deviation power usually is sufficient for use in computing total maximum power for a chip or one or more units thereof. The three-sigma standard deviation power (or other value proportional to the one-sigma standard deviation power) is added to the total estimated average power P_{AVG} to yield a value indicative of the total estimated maximum power P_{MAX} for the circuit design or a portion thereof. It is to be appreciated that higher sigma values (e.g., four-sigma, five-sigma, six-sigma, etc.) can also be utilized to determine maximum power where a higher confidence level is desired for P_{MAX}.

As mentioned above, it is to be understood and appreciated that a similar summation of estimated power could be implemented for different units (e.g., structural or functional units) of a circuit design. The computed average and standard deviation power for each such unit could be summed together to provide the total average and maximum powers. Additionally, where the circuit design has been decomposed into functional units, the estimated average and maximum power values for each functional unit further can be utilized to optimize the design process, such as in the case where one or more functional units may consume an amount of power outside acceptable operating parameters.

A model evaluator 76 can be utilized to control the number of iterations implemented by the statistical model 52. After predetermined criteria has been met, for example, the model evaluator 76 can cause the power calculator 70 to compute estimated power based on the activity data 68. The model evaluator 76 can cause the model 52 to generate estimates for a fixed number of testcases or until some predetermined convergence criterion has been satisfied. For example, the model evaluator 76 can determine whether the estimated mean values in the activity data have adequately saturated, such as to within a predetermined level (e.g., a threshold) relative to one or more preceding estimates. Alternatively, or additionally, the model evaluator 76 can be programmed to implement the statistical model 52 on the testcase data 62 for a fixed number of testcases or until no additional testcases are available for power estimation.

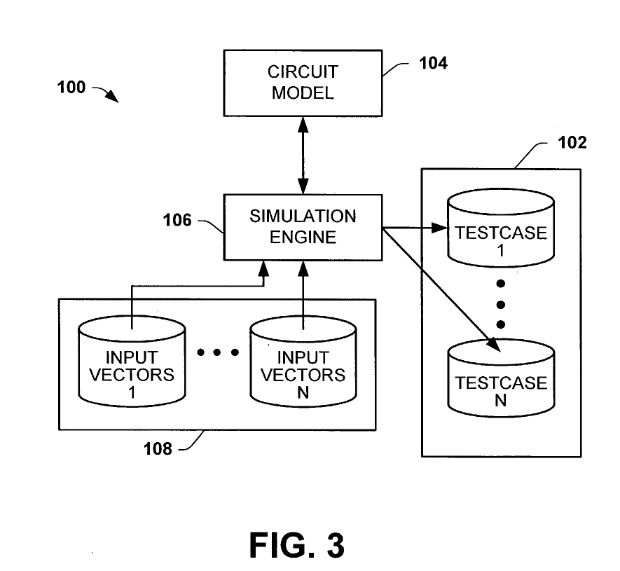

FIG. 3 depicts an example of a simulation system 100 that can be utilized to generate functional verification testcase data 102. The simulation system 100 can include hardware (e.g., a computer) and/or software programmed to functionally verify a circuit design represented by a circuit model 104. The circuit model 104 can be programmed by one or more users to provide a structural and/or behavioral description associated with one or more units of a given integrated circuit design. The circuit model 104 can be generated manually or by employing a CAD tool. The circuit model 104, for example, can represent high-level architectural or structural properties of the circuit design, such as a RTL model.

The simulation system 100 also includes a simulation engine 106 that is operative to functionally verify the circuit model 104 based on a plurality of testcases 108, each testcase including an associated set of input vectors, indicated at INPUT VECTORS 1 through INPUT VECTORS N, where N denotes the number of testcases. Each set of input vectors corresponds to a test case that is employed to stimulate activity of the circuit model 104 for the purpose of functional verification. As mentioned above, many types of integrated circuits are functionally verified through the use of a simulation scheme.

For example, the properties of the circuit design (represented by the model 104) can be employed to obtain an expected state of the processor upon executing a given set of testcases 108. Each set of input vectors can be characterized as a sequence of one or more input patterns capable of testing one or more functional attributes of the circuit design or a particular portion of the design. A given testcase can be utilized to test any function of the circuit design, including control logic, memory, registers, cache, latches and buffers. Each set of input vectors in the testcases 108 can be randomly generated or designed specifically to test a particular functional or structural part of the design.

The simulation engine 106 generates the testcase results 102, indicated at TESTCASE 1 through TESTCASE N, corresponding to the number of testcases. That is, each set of input vectors for a given testcase results in a corresponding one of the testcases, TESTCASE 1 through TESTCASE N. At least some information in the respective testcase data 102 includes behavioral information related to power consumption of the circuit design represented by the model 104. For example, the power related information in TESTCASE 1 through TESTCASE N includes a value indicative of switching activities for one or more respective circuit units.

According to one possible implementation, the simulation engine 106 performs functional verification and derives, among other parameters, switching activity information for the respective of nodes represented in the circuit model 104. A corresponding activity factor value thus can be derived from the switching activity information. For example, the activity factor can be determined based on simulated node level switching characteristics for the plurality of input vectors in each of the input testcases 108. The activity factor thus characterizes switching activity associated with a given node or other circuit unit over a number of clock cycles. The, simulation results provided as TESTCASE 1 through TESTCASE N can include activity factor values computed for the respective nodes of the circuit model 104, or alternatively, the activity factor computations can be performed by other (e.g., external) computing means, such as part of a power estimation system.

As mentioned above, the testcase data 102 can be utilized by a designer or a CAD tool to ascertain whether the circuit design is functionally accurate according to expected design parameters. The testcase data 102 can be stored in memory for use by such components or otherwise provided directly to them through an associated API or buffer. Additionally, such testcase data 102 can be employed for power estimation implemented according to an aspect of the present invention.

As mentioned above, various statistical models can be utilized for power estimation implemented according to an aspect of the present invention. For example, given a set of power-related measurements {pᵢ, i=1, 2, . . . n where n is the number of data points (e.g., testcases) in the measurement set}, one can calculate its mean value μ and standard deviation a of the given data points as follows:

$$\begin{matrix}μ = \frac{1}{n} {\sum }_{i = 1}^{n} {p}_{i} & Eq . 2 \\ {σ}^{2} = \frac{1}{n - 1} {\sum }_{i = 1}^{n} {( {p}_{i} - μ )}^{2} & Eq . 3\end{matrix}$$

The divisor n−1 in Eq. 3 can be replaced by n, although, dividing by n−1 provides an improved (e.g., unbiased) estimation to the variance.

If the number of data points in a measurement set is small, the mean and the standard deviation derived from Eqs. 2 and 3 can be statistically erroneous. However, if one reports the average value of the measurement data as they are obtained consecutively, the average value tends to saturate or converge at a certain level. In particular, as the number of data points n approaches infinity, the saturated average corresponds to the statistical mean.

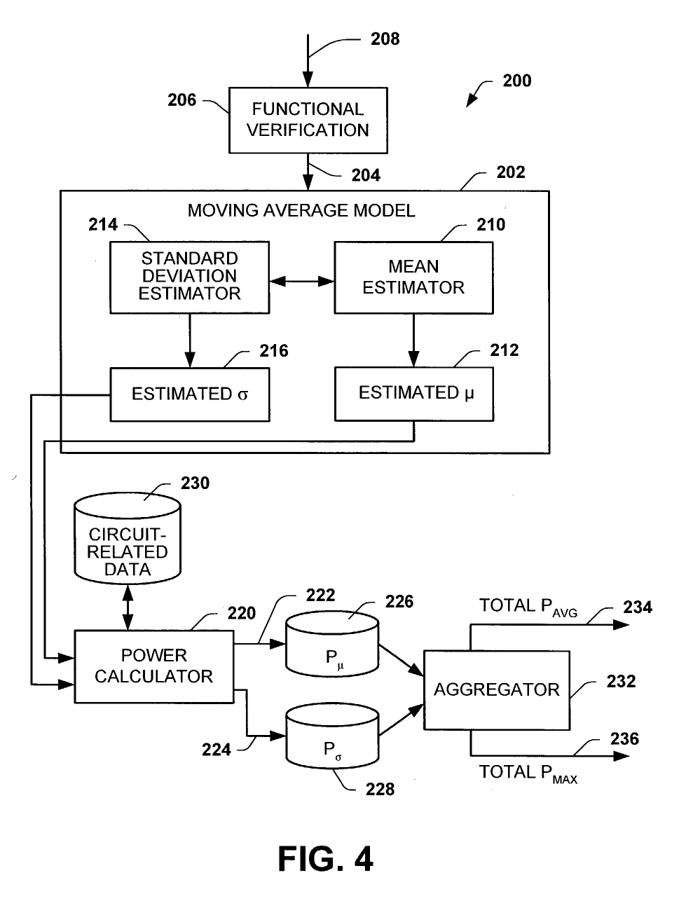

FIG. 4 is an example of a power estimation system 200 implementing a moving average statistical model 202 to estimate power according to an aspect of the present invention. The power estimation system 200 receives functional verification testcase information 204 from a functional verification 206 that is related at least in part to power consumption of the circuit design or a portion thereof. The granularity of information provided by the functional verification 206 generally depends on the type of simulation being employed to implement functional verification.

For example, the testcase information 204 includes information indicative of node-level switching activity over a number of clock cycles based on functional verification implemented for a plurality of input vectors 208. The functional verification information 204 can be utilized to derive a corresponding activity factor, as described herein. The functional verification testcase information 204 can be obtained from an associated memory device (not shown) or be provided directly to the power estimation system 200 by the functional verification 206. The amount of functional verification (e.g., number of testcases) implemented generally depends on the complexity of the circuit being designed. Those skilled in the art will understand and appreciate that functional verification 206 is routinely utilized throughout the design process for many types of integrated circuits to ensure proper functional operation of the circuit, thus often providing extremely large data sets. Accordingly, functional verification information 204 provides valid input space for employing the model 202 for parameter estimation.

A moving average value can be defined as the mean value of the average of the first k testcases, where k is a positive integer greater than or equal to one.

Similarly, a moving average standard deviation can be defined as the standard deviation of the average of the first k data points.

By way of example, let X be a random variable having a normal distributed function with mean μ and standard deviation σ. The moving average of X given n testcases can defined as:

$${V}_{n} = \frac{1}{n} {\sum }_{j = 1}^{n} {X}_{j} \qquad Eq . 4$$

The moment generating function (mₓ(t)) of X with respect to time (t) is the expected value of e^{tX}. Thus,

$$\begin{matrix}{m}_{x} ( t ) = E \{ {ⅇ}^{t X} \} & Eq . 5 \\ = {ⅇ}^{μ t + \frac{1}{2} {σ}^{2} {t}^{2}} & Eq . 6\end{matrix}$$

From Eq. 6, the moment generating function of the moving average V can be calculated as follows:

$$\begin{matrix}{m}_{v} ( t ) = E \{ {ⅇ}^{t V} \} & Eq . 7 \\ = E \{ {ⅇ}^{t} \frac{1}{n} {\sum }_{j = 1}^{n} {X}_{j} \} & Eq . 8 \\ = {\prod }_{j = 1}^{n} E \{ {ⅇ}^{\frac{1}{n} {X}_{j}} \} & Eq . 9 \\ = {\prod }_{j = 1}^{n} {m}_{x} ( \frac{t}{n} ) & Eq . 10 \\ = {\prod }_{j = 1}^{n} {ⅇ}^{μ \frac{1}{2} + \frac{1}{2} {σ}^{2} \frac{{t}^{2}}{{n}^{2}}} & Eq . 11 \\ = {ⅇ}^{n μ \frac{t}{n} + n \frac{1}{2} {σ}^{2} \frac{{t}^{2}}{{n}^{2}}} & Eq . 12 \\ = {ⅇ}^{μ t + \frac{1}{2} \frac{{σ}^{2}}{n} {t}^{2}} & Eq . 13\end{matrix}$$

The moment generating function of V maps to a normal distribution function having mean value μ and standard deviation σ.

In view of the above, the moving average model 202 thus includes a mean estimator 210 that estimates a mean 212 based on the functional verification information 204. The mean estimator 210, for example, determines the mean from the distribution associated with the moving average function, such as defined by Eq. 13. The estimated mean 212, for example, includes estimated mean values for each node in the circuit design being functionally verified. The mean values further varies according to the number of data points k employed for computing a moving average. The number k, for example, can be selected according to the expected number of testcases, as a large number of k tends to mitigate fluctuations in the testcase information 204.

The model 202 also includes a standard deviation estimator 214 that determines a standard deviation 216 for respective nodes in the circuit design. The standard deviation estimator 214, for example, can derive the moving average standard deviation estimates 216 as a function of the estimated mean values 212 (e.g., to according to Eq. 13).

The estimated mean 212 and standard deviation 216 are provided to a power calculator 220. The power calculator 220 computes a mean unit power estimate (P_{μ}) 222 and a standard deviation unit power estimate (P_{σ}) 224 respectively represented (for purposes or illustration) at 226 and 228. The power calculator 220 computes the unit estimates 222 and 224 based on the estimated mean 212, the estimated standard deviation 216 and other circuit-related data 230. The power calculator 220, for example computes the power estimates for every k testcases according to the power equation (e.g., Eq. 1).

The circuit-related data 230 provides values indicative of the various parameters, as mentioned above with respect to Eq. 1. For example, the circuit-related data 230 includes the load capacitance associated with each respective nodes (or other circuit units for which the mean and standard deviation values are estimated), as well as the V_{DD}, f_{clk} associated with the circuit design. The circuit-related data 230 can be provided by the simulation (e.g., based on the circuit model or description) or otherwise be determined and provided to the power calculator 230 of the estimation system 200.

Where mean and standard deviation unit power estimates are computed by the power calculator 230, an aggregator 232 is included to provide a total average power 234 and a total maximum power 236. The aggregator 232, which could be implemented as part of the power calculator 220, generates the total average power 234 by summing the unit-level mean power values 226. For example, the total average power 234 for a circuit design corresponds to the sum of the mean power consumed at each respective node (e.g., in a RTL model), as computed by the power calculator 220. Additionally, the total maximum power 236 is provided by summing the unit-level standard deviation power values 228 and adding the total standard deviation power to the total average power 234.

Those skilled in the art will understand and appreciate that such an approach enables both average and maximum power to be computed substantially concurrently by a given model 202 based on a common set of testcases. The number of testcases can be fixed. Alternatively, the number of testcases can be arbitrary or variable, in which case the power estimation system 200 can continue to generate the total power values 234 and 236, for example, until the average power sufficiently converges or until no additional functional verification is required (e.g., the design process has completed). Because the functional verification data is obtained over a plurality of testcases, usually over extended periods of time various other models could be utilized to estimate the power-related parameters. Examples of these other approaches include autoregressive models and/or variations on the moving average statistics, to name a few.

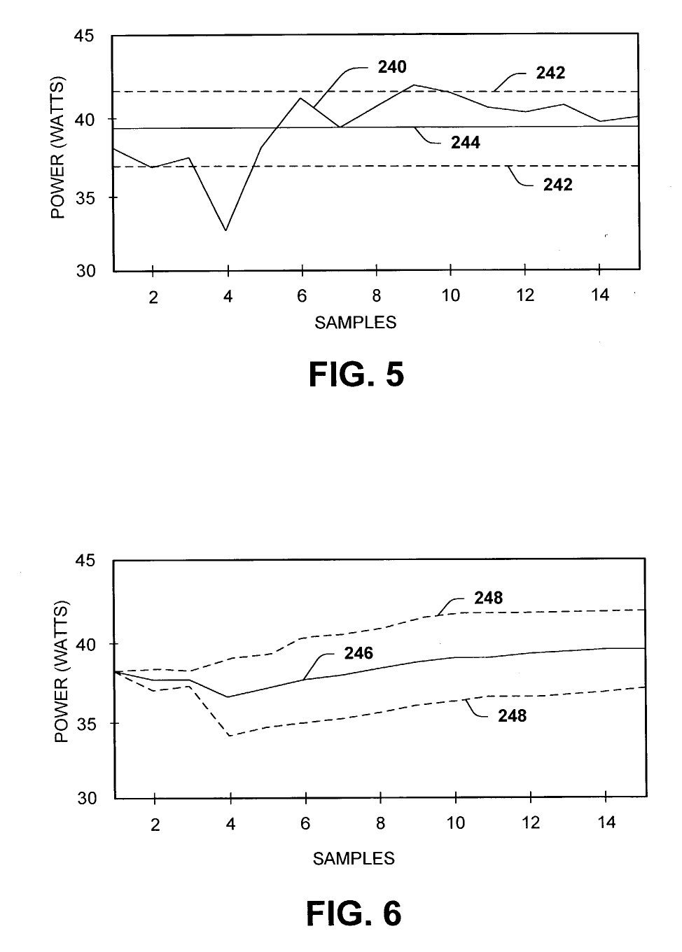

By way of comparison, FIGS. 5 and 6 examples of power consumption estimated by different techniques, in which power is plotted as a function of input samples, namely, testcases. In particular, FIG. 5 shows the average power consumed by a microprocessor design due to 15 testcases represented by mean value level 240 and its confidence range 242. Also depicted in FIG. 5 is the simple average power 244 for the same set of testcases.

FIG. 6 shows an example of power estimates determined by moving average statistics, such according the example of FIG. 4, due to the same testcases in the same order as in FIG. 5. Specifically, FIG. 6 illustrates mean power estimates 246 and its associated confidence range 248 over the set of testcases. Based on the 15 testcases utilized in this example, the moving average statistics provided a mean estimated power μ=39.3 Watts (W) and standard deviation σ=2.3 W, translating to a maximum power of about 41.6 W. Furthermore, from the moving average curve of FIG. 6, it can be observed that it saturates at around the mean. Similar observations can be made to individual units in the design. Accordingly, the power analysis of the moving average of power consumption can be decomposed for each unit in the design into shape function and a saturation level factor. These values can be further estimated using the other statistical models, as described herein.

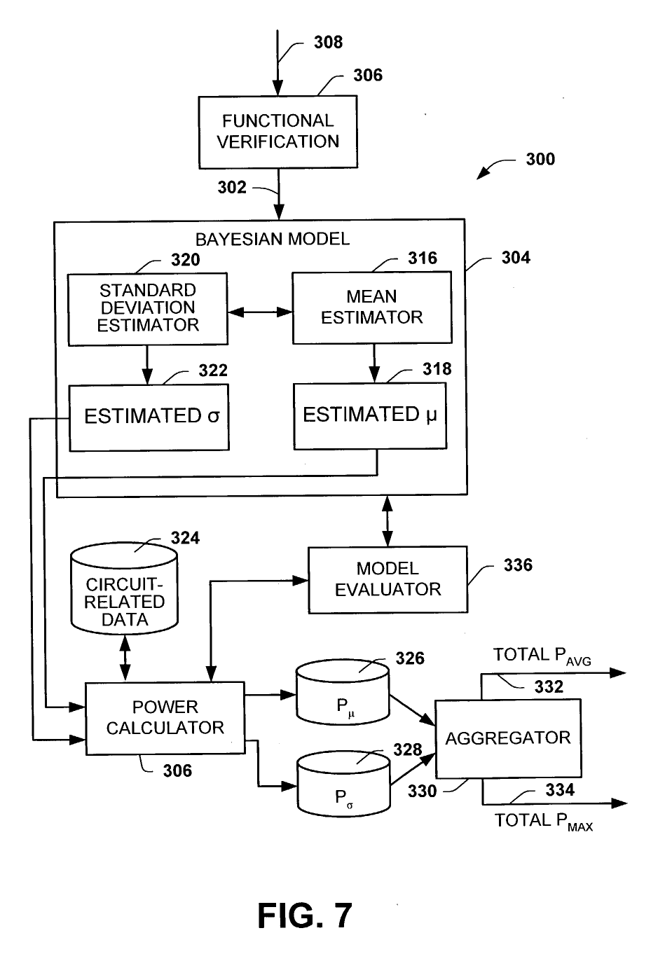

FIG. 7 depicts another example of a system 300 that can be utilized to estimate power based on functional verification data 302 in accordance with an aspect of the present invention. In this example, the power estimation system 300 employs a Bayesian model 304 to estimate one or more parameters associated with activity of a circuit design. The parameters, for example, correspond to switching activity that can be estimated based on the functional verification information 302 over a plurality of testcases. The functional verification information 302 can be substantially similar to that employed by the example of FIG. 4.

Briefly stated, functional verification 306 is implemented at various stages throughout the design process on a circuit model, such as a RTL model. The functional verification 306 provides an indication of switching characteristics over a set of input vectors. Thus, an activity factor for a given node or other circuit juncture can be derived for a given testcase based on the state transitions over a number of clock cycles. Thus, the information 302 can correspond to activity factors for a plurality of nodes for each respective testcase.

The amount of functional verification implemented for a given circuit design generally depends on the complexity of the circuit being designed. For larger data sets, a moving average of the functional verification information 302 can be employed to facilitate convergence with the Bayesian estimation process. Additionally or alternatively, the functional verification information 302 can be sorted prior to applying the model 304 to such data.

The Bayesian model 304 estimates the mean and standard deviation the node-level switching activities of the circuit model (e.g., RTL model) through the functional verification 306. The Bayesian model 304 updates the estimated mean and standard deviation data over a plurality of testcases. As a greater number of testcases are utilized, the estimated mean provided by the Bayesian model 304 tends to converge or saturate to an associated value. The Bayesian model 304 provides the resulting estimated mean and standard deviation for the node-level switching activities to a power calculator 306 for computing estimated power consumption.

By way of example, the Bayesian model 304 includes a mean estimator 316, such as a Bayesian estimator programmed and/or configured to estimate a mean activity factor based on activity factors derived from the functional verification over plural testcases. During the estimation process, the mean estimator 316 utilizes the functional verification 302 associated with different testcases to update the model and estimate a new mean 318. The Bayesian model 304 also includes a standard deviation estimator 320 that is operative to compute a standard deviation for the activity factor, which is functionally related to the estimated mean 318. The estimators 316 and 320, for example, estimates the mean 318 and standard deviation 322 for each node in the circuit being designed or for one or more selected units of the circuit. That is, the circuit design can be divided into units and the power estimation system 300 be applied by decomposing the model (e.g., into corresponding sub-models) to estimate average and maximum power for each respective unit.

By way of further example, the statistical model assumes the average power consumption of a certain unit of a chip is a random variable distributed as a normal function with certain mean and standard deviation. One can apply n testcases to the functional verification 306 that generates the power-related information to enable the power estimation system 300 to estimate the statistics of the unit power consumptions and observe n power values for each unit, \vec{p}=pᵢ for i=1 . . . n. Each data point pᵢ is a sample from the assumed distribution function of the average power of the unit. The samples \vec{p} can have the same normal distribution function with either the same mean and standard deviation values or different mean and different standard deviation values. The following example assumes a general case where the mean and standard deviation values of each observation are different, but they obey the normal distribution function.

In view of the above assumptions and nomenclature, let P be a random variable representing the average power consumption of a given unit in a chip. Let P be normally distributed with unknown mean μ and unknown standard deviation σ. Thus,

$$P ∼ f p ( p ) = \frac{1}{\sqrt{2 π σ}} {ⅇ}^{\frac{- {( p - μ )}^{2}}{2 {σ}^{2}}} \qquad Eq . 14$$

In this example, assume the samples from the normal distribution function of Eq. 14 have different parameters μ, σ but the same normal function. Therefore, these parameters can be represented as:

μ=μᵢ=μ₀gᵢ, for i=1 . . . n and Eq. 15

σ=σᵢ=σ₀uᵢ, for i=1 . . . n Eq. 16

where: μ₀ and σ₀ are fixed (but unknown) for all samples, and

gᵢ and uᵢ are arbitrary functions controlled by the statistics of

the input testcases i=1 . . . n.

Based on \vec{p}, the likelihood function of μ₀ and σ₀ can be measured assuming they are the a priori random variables:

$$\begin{matrix}L ( {μ}_{0} {σ}_{0} \vert \vec{p} ) = {\prod }_{i = 1}^{n} f p ( {p}_{i} \vert {μ}_{0} , {σ}_{0} ) & Eq . 17 \\ = {\prod }_{i = 1}^{n} \frac{1}{\sqrt{2 {π}_{i}} {σ}_{0} μ} {ⅇ}^{- \frac{{( {p}_{i} - {μ}_{0 g i} )}^{2}}{2 {σ}_{0}^{2} {μ}_{i}^{2}}} & Eq . 18 \\ = {( \frac{1}{\sqrt{2 π}} )}^{n} ( \frac{1}{{\prod }_{i}^{n} = 1 {μ}_{i}^{2}} ) \frac{1}{{σ}_{0}^{n}} {ⅇ}^{- \frac{1}{2 {σ}_{0}^{2}} {\sum }_{i = 1}^{n} {( \frac{p i - {μ}_{0} {g}_{i}}{{μ}_{i}} )}^{2}} & Eq . 19 \\ = {( \frac{1}{\sqrt{2 π}} )}^{n} ( \frac{1}{{\prod }_{i}^{n} = 1 {μ}_{I}^{2}} ) \\ \frac{1}{{σ}_{0}^{n}} {ⅇ}^{- \frac{1}{2 {σ}_{0}^{2}} ( {\sum }_{i = 1}^{n} \frac{{p}_{i}^{2}}{{μ}_{i}^{2}} + {μ}_{0}^{2} {\sum }_{i = 1}^{n} \frac{{g}_{i}^{2}}{{μ}_{i}^{2}} - 2 {μ}_{0} {\sum }_{i = 1}^{n} \frac{{p}_{i} {g}_{i}}{{μ}_{i}^{2}} )} & Eq . 20\end{matrix}$$

For simplification, the following quantities can be abbreviated, as follows:

$$\begin{matrix}{M}_{n} = \frac{1}{n} {\sum }_{i = 1}^{n} \frac{{p}_{i}^{2}}{{μ}_{i}^{2}} & Eq . 21 \\ {G}_{n} = \frac{1}{n} {\sum }_{i = 1}^{n} \frac{{g}_{i}^{2}}{{μ}_{i}^{2}} & Eq . 22 \\ {Q}_{n} = \frac{1}{n} {\sum }_{i = 1}^{n} \frac{{p}_{i} {g}_{i}}{{μ}_{i}^{2}} & Eq . 23 \\ {U}_{n} = {( \frac{1}{\sqrt{2 π}} )}^{n} {\prod }_{i - 1}^{n} \frac{1}{{u}_{i}} & Eq . 24\end{matrix}$$

In a situation where it can be assumed that all testcases have similar statistics, when gᵢ=1 and uᵢ=1 for all input testcases i=1 . . . n. For purposes of brevity and simplification, the following example assumes such similar statistics exist. From Eqs. 21-24, we have Mₙ=s²+\overline{X}², Gₙ=1 and Qₙ=\overline{X}, which corresponds to a simple type of Bayesian model where all samples are from the same distribution. Substituting these terms in the likelihood function of Eq. 20 provides:

$$\begin{matrix}L ( {μ}_{0} , {σ}_{0} \vert \vec{p} ) = {U}_{n} \frac{1}{σ \frac{n}{0}} {ⅇ}^{- \frac{1}{2 {σ}_{0}^{2}} ( n {M}_{n} + n {μ}_{0}^{2} {G}_{n} - 2 n {μ}_{o} {Q}_{ n} )} & Eq . 25 \\ = {U}_{n} \frac{1}{{σ}_{0}^{n}} {ⅇ}^{- \frac{n}{2 {σ}_{0}^{2}} ( {G}_{n} {μ}_{0}^{2} - 2 {Q}_{n} {μ}_{0} + {M}_{ n} )} & Eq . 26\end{matrix}$$

To simplify the Bayesian calculations for σ₀, the standard deviation can be represented by:

$$ζ = \frac{1}{{σ}_{0}^{2}} \qquad Eq . 27$$

Assume μ₀ and ζ are independent with the following priori distribution functions:

$$\begin{matrix}{μ}_{0} ∼ φ ( v , {τ}^{2} ) = \frac{1}{\sqrt{2 π r} τ} {ⅇ}^{- \frac{{( {μ}_{0} - v )}^{2}}{2 {τ}^{2}}} & Eq . 28 \\ ζ ∼ Γ ( γ , r ) = \frac{{γ}^{r}}{Γ ( r )} {ζ}^{r - 1} {ⅇ}^{- γ } ζ > 0 & Eq . 29\end{matrix}$$

From the likelihood and priori distribution functions, the Bayesian estimates of the parameters μ₀ and ζ can be calculated given n testcases that were applied and yielded n data points \vec{p}. Since independency is assumed, the Bayesian estimates of μ₀ and ζ can be calculated independently.

For purposes of the following example, let \hat{μ}₀ be the Bayesian estimate of μ₀, and \hat{ζ} be the Bayesian estimate of ζ. By applying Bayesian rules, the Bayesian estimate of μ₀ can be expressed as follows:

$$\begin{matrix}E ( {μ}_{0} \vert \vec{p} ) = \frac{{\int }_{- ∞}^{∞} {μ}_{0} L ( {μ}_{0} \vert \vec{p} ) {f}_{M} ( {μ}_{0} ) ⅆ {μ}_{0}}{{\int }_{- ∞}^{∞} L ( {μ}_{0} \vert \vec{p} ) {f}_{M} ( {μ}_{0} ) ⅆ {μ}_{0}} & Eq . 30 \\ = \frac{{\int }_{- ∞}^{∞} {μ}_{0} {U}_{n} \frac{1}{{σ}_{0}^{n}} {e}^{- \frac{n}{2 σ \frac{2}{0}} ( {G}_{n} {μ}_{0}^{2} - 2 {Q}_{n} {μ}_{0} + {M}_{n} )} \frac{1}{\sqrt{2 π} τ} {e}^{- \frac{{( {μ}_{0} - v )}^{2}}{2 {τ}^{2}}} ⅆ {μ}_{0}}{{\int }_{- ∞}^{∞} {U}_{n} \frac{1}{{σ}_{0}^{n}} {e}^{- \frac{n}{2 σ \frac{2}{0}} ( {G}_{n} {μ}_{0}^{2} - 2 {Q}_{n} {μ}_{0} + {M}_{n} )} \frac{1}{\sqrt{2 π} τ} {e}^{- \frac{{( {μ}_{0} - v )}^{2}}{2 {τ}^{2}}} ⅆ {μ}_{0}} & E q . 31 \\ = \frac{{\int }_{- ∞}^{∞} {μ}_{0} {e}^{- \frac{n}{2 σ \frac{2}{0}} ( {G}_{n} {μ}_{0}^{2} - 2 {Q}_{n} {μ}_{0} + {M}_{n} )} {e}^{- \frac{{( {μ}_{0} - v )}^{2}}{2 {τ}^{2}}} ⅆ {μ}_{0}}{{\int }_{- ∞}^{∞} {e}^{- \frac{n}{2 σ \frac{2}{0}} ( {G}_{n} {μ}_{0}^{2} - 2 {Q}_{n} {μ}_{0} + {M}_{n} )} {e}^{- \frac{{( {μ}_{0} - v )}^{2}}{2 {τ}^{2}}} ⅆ {μ}_{0}} & E q . 32\end{matrix}$$

The numerator and denominator of Eq. 32 can be formed as integrals of a normal distribution function with respect to μ₀ by multiplying the integrals by some constants. Therefore, the common exponent term of Eq. 32 can be rewritten in the form:

$${e}^{- \frac{{( {μ}_{0} - \hat{μ} )}^{2}}{2 {s}^{2}}} \qquad Eq . 33$$

where the Bayesian estimate of μ₀ becomes:

$$E ( {μ}_{0} \vert \vec{p} ) \frac{{\int }_{- ∞}^{∞} {μ}_{0} φ ( {μ}_{0} , {s}^{2} ) ⅆ {μ}_{0}}{{\int }_{- ∞}^{∞} φ ( {μ}_{0} , {s}^{2} ) ⅆ {μ}_{0}} = \frac{{μ}_{0}}{1} = {μ}_{0} \qquad Eq . 34$$

The power of the exponent term of Eq. 32 is therefore:

$$\begin{matrix}- \frac{{( {μ}_{0} - {\hat{μ}}_{0} )}^{2}}{2 {s}^{2}} = - \frac{n}{2 {σ}_{0}^{2}} ( {G}_{n} {μ}_{0}^{2} - 2 {Q}_{n} {μ}_{0} + {M}_{n} ) - \frac{1}{2 {τ}^{2}} {( {μ}_{0} - v )}^{2} & Eq . 35 \\ = - \frac{1}{2 {σ}_{0}^{2} {τ}^{2}} [ n {τ}^{2} {G}_{n} {μ}_{0}^{2} - 2 n {τ}^{2} {Q}_{n} {μ}_{0} + n {τ}^{2} {M}_{n} + {σ}_{0}^{2} {μ}_{0}^{2} + {σ}_{0}^{2} {v}^{2} - 2 {σ}_{0}^{2} v {μ}_{0} ] & Eq . 36 \\ = - \frac{1}{2 {σ}_{0}^{2} {τ}^{2}} [ ( n {τ}^{2} {G}_{n} + {σ}_{0}^{2} ) {μ}_{0}^{2} - 2 ( n {τ}^{2} {Q}_{n} + {σ}_{0}^{2} v ) {μ}_{0} + ( n {τ}^{2} {M}_{n} + {σ}_{0}^{2} {v}^{2} ) ] & Eq . 37 \\ = - \frac{n {τ}^{2} {G}_{n} + {σ}_{0}^{2}}{2 {σ}_{0}^{2} {τ}^{2}} [ {μ}_{0}^{2} - 2 \frac{n {τ}^{2} {Q}_{n} + {σ}_{0}^{2} v}{n {τ}^{2} {G}_{n} + {σ}_{0}^{2}} {μ}_{0} + \frac{n {τ}^{2} {M}_{n} + {σ}_{0}^{2} {v}^{2}}{n {τ}^{2} {G}_{n} + {σ}_{0}^{2}} ] & Eq . 38\end{matrix}$$

To form a complete square factor of the quadratic term of μ₀ from Eq. 38, the square of half the coefficient of μ₀ can be added and then subtracted back. In the integral, this addition in the exponent will be a multiplication by a constant on both the numerator and denominator, which will not affect the estimation. The exponent term will then become:

$$- \frac{{( {μ}_{0} - {\hat{μ}}_{0} )}^{2}}{2 {s}^{2}} = - {\frac{n {τ}^{2} {G}_{n} + {σ}_{0}^{2}}{2 {σ}_{0}^{2} {τ}^{2}} [ {μ}_{0} - \frac{n {τ}^{2} {Q}_{n} + {σ}_{0}^{2} v}{n {τ}^{2} {G}_{n} + {σ}_{0}^{2}} ]}^{2} + K \qquad Eq . 39$$

where K is an adjusting constant employed to the complete square factor.

Therefore, \hat{μ}₀ (e.g., corresponding to the estimated mean 318) is:

$${\hat{μ}}_{0} = \frac{n {τ}^{2} {Q}_{n} + {σ}_{0}^{2} v}{n {τ}^{2} {G}_{n} + {σ}_{0}^{2}} \qquad Eq . 40$$

The Bayesian estimate of ζ (e.g., functionally related to the estimated standard deviation 322) given the history testcase data \vec{p} can similarly be calculated, as follows:

$$\begin{matrix}E ( ζ \vert \vec{p} ) = \frac{{\int }_{0}^{∞} ζ L ( ζ \vert \vec{p} ) f z ( ζ ) ⅆ ζ}{{\int }_{0}^{∞} L ( ζ \vert \vec{p} ) f z ( ζ ) ⅆ ζ} & Eq . 41 \\ = \frac{{\int }_{0}^{∞} ζ {U}_{n} \frac{1}{{σ}_{0}^{n}} {e}^{- \frac{n}{2 σ \frac{2}{0}} ( {G}_{n} {μ}_{0}^{2} - 2 {Q}_{n} {μ}_{0} + {M}_{n} )} \frac{{γ}^{r}}{Γ ( r )} {ζ}^{r - 1} {e}^{- γζ} ⅆ ζ}{{\int }_{0}^{∞} {U}_{n} \frac{1}{{σ}_{0}^{n}} {e}^{- \frac{n}{2 σ \frac{2}{0}} ( {G}_{n} {μ}_{0}^{2} - 2 {Q}_{n} {μ}_{0} + {M}_{n} )} \frac{{γ}^{r}}{Γ ( r )} {ζ}^{r - 1} {e}^{- γζ} ⅆ ζ} & E q . 42 \\ = \frac{{\int }_{0}^{∞} {ζζ}^{\frac{n}{2} + r - 1} {e}^{- \frac{n}{2} ζ ( {G}_{n} {μ}_{0}^{2} - 2 {Q}_{n} {μ}_{0} + {M}_{n} ) - γζ} ⅆ ζ}{{\int }_{0}^{∞} {ζ}^{\frac{n}{2} + r - 1} {e}^{- \frac{n}{2} ς ( {G}_{n} {μ}_{0}^{2} - 2 {Q}_{n} {μ}_{0} + {M}_{n} ) - γζ} ⅆ ζ} & E q . 43\end{matrix}$$

Similarly, Eq. 43 can be formed as integrals of a Gamma distribution function with updated parameters r and γ. Thus, the updated parameters can be expressed as:

$$\begin{matrix}{r}^{+} = \frac{n}{2} + r & Eq . 44 \\ {γ}^{+} = \frac{n}{2} ( {G}_{n} {μ}_{0}^{2} - 2 {Q}_{n} {μ}_{0} + {M}_{n} ) + γ & E q . 45\end{matrix}$$

Therefore, the Bayesian expectation of ζ is the expected value of Gamma function:

$$\hat{ζ} = \frac{{r}^{+}}{{γ}^{+}} = \frac{\frac{n}{2} + r}{\frac{n}{2} ( {G}_{n} {μ}_{0}^{2} - 2 {Q}_{n} {μ}_{0} + {M}_{n} ) + γ} \qquad Eq . 46$$

where γ and r are the initial guess parameters for ζ or σ.

By way of further example, if an initial guess for the standard deviation σ is chosen to be 1, then γ and r can both be selected to approach zero. Therefore, the Bayesian estimate of ζ becomes:

$$\hat{ζ} = \frac{1}{{G}_{n} {μ}_{0}^{2} - 2 {Q}_{n} {μ}_{0} + {M}_{n}} \qquad Eq . 47$$

Utilizing Eqs. 15 and 35, the Bayesian estimate of the variance σ₀² is:

σ₀²=Gₙμ₀²−2Qₙμ₀+Mₙ Eq. 48

Thus, the Bayesian estimate of the standard deviation σ₀ can be readily determined from Eq. 48. Since \hat{μ}₀ and \hat{σ}₀ are functionally related to each other, Eqs. 48 and 40 can be utilized to solve for \hat{μ}₀ which provides:

$${μ}_{0} = \frac{n {τ}^{2} {Q}_{n} + ( {G}_{n} {μ}_{0}^{2} - 2 {Q}_{n} {μ}_{0} + {M}_{n} ) v}{n {τ}^{2} {G}_{n} + ( {G}_{n} {μ}_{0}^{2} - 2 {Q}_{n} {μ}_{0} + {M}_{n} )} \qquad Eq . 49$$

which can be expanded as follows:

(nτ²Gₙ+Gₙμ₀²−2Qₙμ₀+Mₙ)μ₀=nτ²Qₙ+(Gₙμ₀²−2Qₙμ₀+Mₙ)ν Eq. 50

Factorizing Eq. 50 as a polynomial function of μ₀, provides a third order polynomial equation with respect to μ₀ as follows:

(Gₙ)μ₀³−(νGₙ+2Qₙ)μ₀²+(2νQₙ+nτ²Gₙ+Mₙ)μ₀−(νMₙ+nτ²Qₙ)=0 Eq.51

Thus, Eq. 51 can be solved for real values of μ₀>0 (e.g., either numerically or analytically) and obtain \hat{σ}₀.

Referring back to FIG. 7, the Bayesian estimated mean 318 and standard deviation 322 are provided to the power calculator 306. The power calculator 306 computes an average unit power and a standard deviation unit power based on the estimated mean 318, the estimated standard deviation 322 and power factor data 324 (e.g., node-level C_{LOAD}, V_{DD}, and f_{clk.} for circuit being designed). The power computations based on the estimated model parameters 318 and 322 can be implemented similarly to the approach shown and described with respect to FIG. 4.

For example, the power calculator 306 provides the mean unit power estimates 326 and standard deviation unit power estimates 328 for the respective nodes represented in the circuit model. An aggregator 330 provides an estimated total average power 332 based on the sum mean unit power estimates 326. The aggregator also provides a total maximum power P_{MAX} 334 that is functionally related to the standard deviation unit power values 328 and the total average power 332. A total standard deviation value proportional to the sum of standard deviation unit power values 328 (e.g., a total three-sigma standard deviation power) can be added to the total average power 332. The aggregator 330 could be implemented as part of the power calculator 306. The total power estimates 332 and 334, for example, can be the total power for the entire circuit being designed or, alternatively, for one or more selected units of the circuit.

Those skilled in the art will understand and appreciate that the foregoing approach employing the Bayesian model 304 enables both average and maximum power to be computed by a common statistical model based on common input vectors. Consequently, the estimation process may be implemented more efficiently than other processes, such as those that require generation of specialized input vectors for computing different types of power characterizations. Additional efficiencies are achieved by utilizing functional verification testcases for dual purposes; namely, to generate the input space for the Bayesian model 304 and to functionally verify operation of the circuit.

The power estimation system 302 can also include a model evaluator 336 to evaluate the results of the estimation. In one implementation, the model evaluator 336 can evaluate the total estimated average power 332 over a plurality of testcases to ascertain whether the average power has adequately saturated or converged to within a predetermined power threshold. Adequate convergence, for example, can be gauged by ascertaining an asymptotic average power value, which corresponds to the average power as n→∞. Once the total estimated average power 332 has adequately converged, the power estimation system 300 provides substantially accurate average and maximum power values.

Alternatively or additionally, the model evaluator 336 can evaluate the Bayesian process for some or all estimated unit-level mean values 318 based on predetermined convergence criteria. For example, the model evaluator 336 can evaluate mean activity factor values estimated for the plurality of nodes to ascertain whether the activity factor for a sufficient sample of nodes in the circuit model (e.g., one or more) have converged or saturated to respective values. Once adequate conversion is reached, the average power estimates can be computed based on the updated mean and standard deviation estimates 318 and 322.

The convergence of the power estimation process can be facilitated by fitting the estimated power parameters to an asymptotic curve. For example, the model 304 can employ an asymptotic function hi (taken as i→∞) to modify the estimated mean values 318. The asymptotic function is operative to predict a saturation point μ₀ corresponding to the Bayesian mean estimate (see, e.g., Eqs. 40 and 49). By way of example, the asymptotic function can be defined as follows:

$${h}_{i} = β + \frac{α}{i} \qquad Eq . 51$$

where β and α are the least squared estimates for fitting hᵢ to the estimated moving average data points.

It will be appreciated that the curve fitting can be facilitated further by sorting, which sorting can be implemented in conjunction with a moving average function applied to the functional verification information 302. The sorting of the data points corresponding to the Bayesian estimated mean 318 mitigates fluctuations from the moving average data points that are utilized by the curve fitting function hᵢ. Those skilled in the art will understand processes or techniques other than least square estimates that can be utilized to fit the moving average data points to a corresponding asymptotic function. For example, the asymptotic function could employ an expectation-maximization algorithm or other curve fitting function.

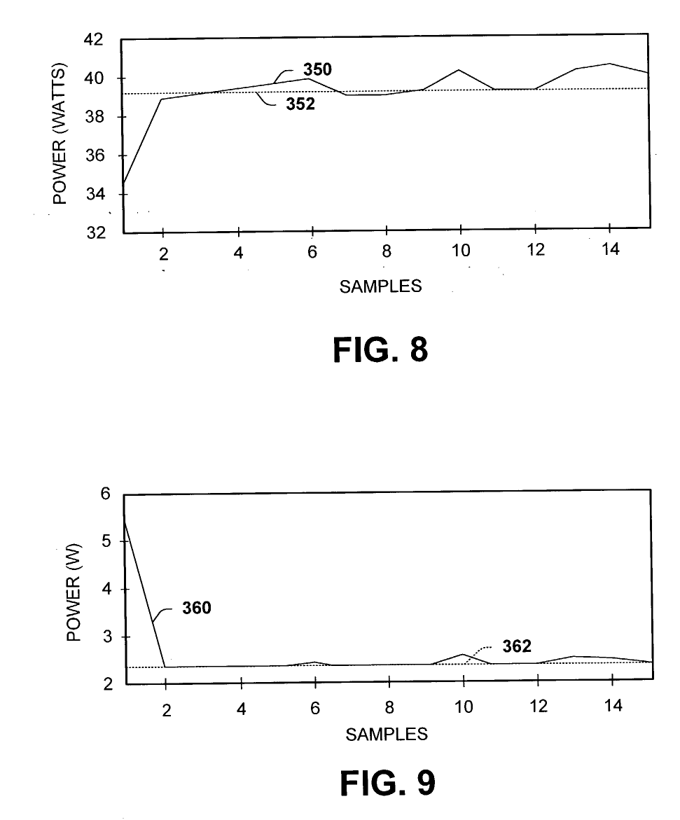

FIGS. 8 and 9 are graphs depicting estimated mean and standard deviation of total chip power that were ascertained using a Bayesian model according to an aspect of the present invention. For each of the examples of FIGS. 8 and 9, fifteen testcases were utilized to implement the Bayesian process for estimating the mean and standard deviation parameters from which corresponding power was computed. The testcases associated with each of the data points were sufficiently large (e.g., consisting of tens of thousands of cycles) so that the testcases collectively present a broad spectrum of switching profiles in the circuit design.

In FIG. 8, power is plotted as a function of the samples (e.g., testcases) utilized as data points to implement the Bayesian estimation process and associated power calculations. In particular, FIG. 8 depicts a total estimated mean power 350 as well as a simple average estimated power 352. From FIG. 8, it is shown that the estimation for the mean value 350 is higher than the simple average estimation by approximately 3.5%. In particular, the estimated mean power 350 ranges generally from about 38.9 W to about 40.7 W, with an average of about 39.62 W. A simple averaging method for estimating the average power provided an average estimation 352 of about 39.3 W.

Turning to FIG. 9, standard deviation power is plotted as a function of samples (e.g., testcases) as determined by employing a Bayesian estimation process and a simple average method, indicated at 360 and 362, respectively. As shown in FIG. 9, the Bayesian estimated standard deviation 360 provides an increase in the power estimation when compared to the standard deviation 362 for the simple averaging method for the same samples. In particular, the Bayesian model estimates the standard deviation on the average chip power to be about σ=2.6 W, whereas the simple average method provides σ=3.3 W. Overall, a Bayesian model implemented in accordance with an aspect of the present invention estimated the standard deviation to be in the range from about 2.3 to about 2.6. The results of a general Bayesian model is dependent on the initial guess utilized from among the data points in the sample data. Thus, additional improvements in the estimation could be realized by selecting the initial guess more carefully, such as based on a number of data points, empirical studies with the circuit design or prior generation chips. As mentioned above, the estimated standard deviation can be utilized (e.g., by an aggregator or power calculator) to obtain a worst case or a maximum power consumption for a given design.

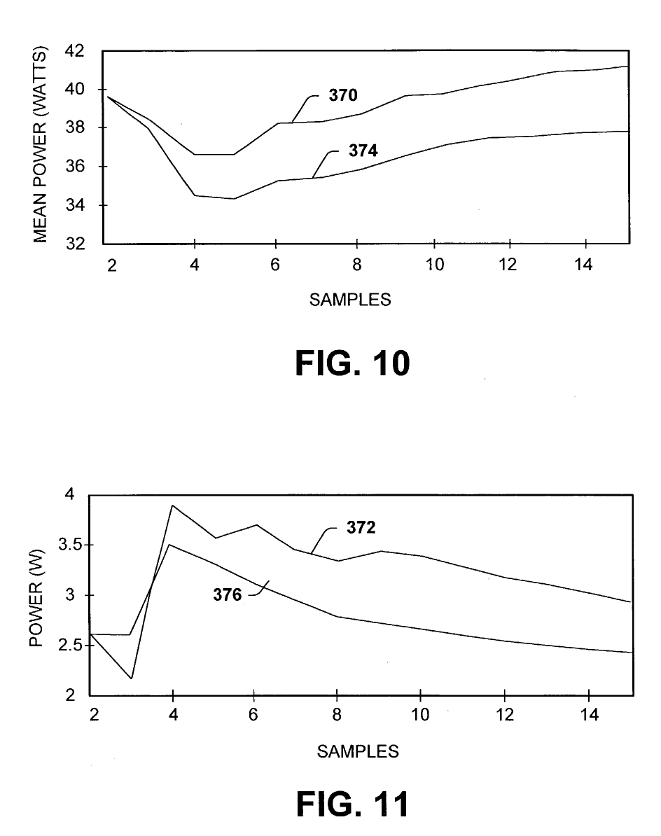

FIGS. 10 and 11 illustrate additional examples in which a Bayesian model has been implemented to estimate mean and standard deviation for power consumption for a given circuit design. In the examples of FIG. 10 and 11, fewer data sets were utilized than the examples described above with respect to FIGS. 8 and 9. In particular, FIG. 10 depicts the estimated mean power 370 and FIG. 11 depicts the estimated standard deviation 372 that were estimated with the same Bayesian model, although for fewer data sets than the examples depicted in FIG. 8 and 9. Also depicted in FIG. 10 and 11, for purposes of comparison, are moving average estimates for the average power, indicated at 374 in FIG. 10, and the moving average standard deviation, indicated at 376 in FIG. 11.

By way of further comparison, a chip corresponding to the examples of FIGS. 8-11 had an average power measure of about 42 W based on actual experimental simulation results. Thus, those skilled in the art will appreciate that Bayesian estimation, which can be implemented in accordance with an aspect of the present invention, provides a closer approximations to the actual average power consumption than simple averaging or moving averaging statistics on like data sets.

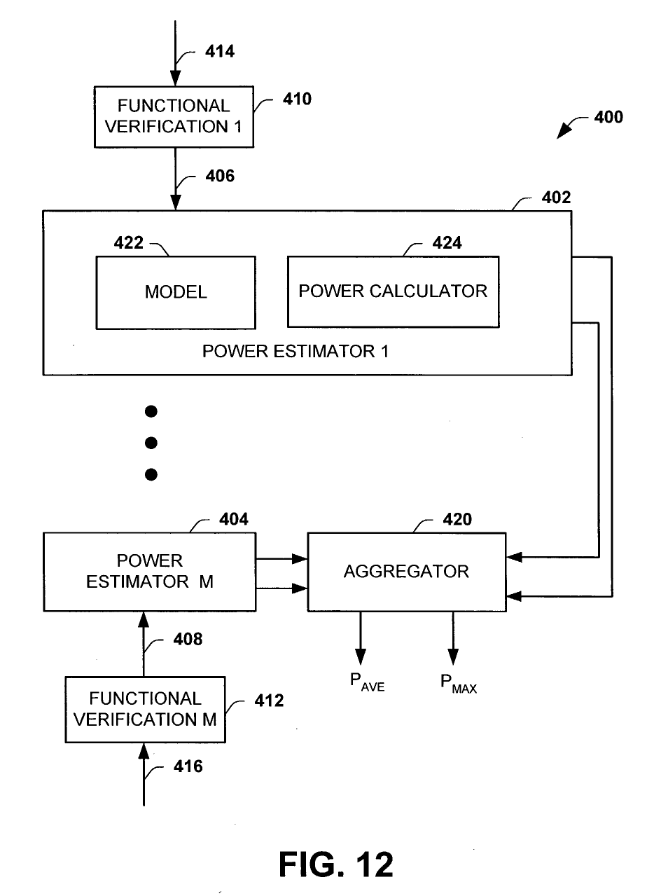

FIG. 12 is an example of a system 400 that can be implemented to estimate power for a plurality of units that collectively form a circuit design or a substantial portion thereof. In this example, M power estimators 402 and 404 are associated with respective units of the circuit design, where M is a positive integer greater than or equal to one. The different units of the circuit design can correspond to distinct functional and/or structural blocks of the design. The power estimators 402 and 404 compute power estimates based on functional verification information (e.g., testcase results) 406 and 408, respectively. The functional verification information 406 and 408 is provided by functional verification 410 and 412 performed on the circuit model based on respective input vectors 414 and 416.

The respective sets of input vectors 414 and 416 are utilized to verify functional operation of the circuit design, and not specifically developed for power estimation purposes. As mentioned above, such functional verification is routinely implemented during the design process of integrated circuits, including microprocessors and application specific integrated circuits (ASICs). The respective input vectors 414 and 416 can be designed particularly to selectively exercise the structural or functional units of the circuit design. In this way, different amounts of functional verification can be implemented on different circuit units throughout the design process.

The power estimators 402 and 404 are programmed and/or configured to estimate power based on the functional verification information 406 and 408 associated with respective circuit units. The power estimators 402 and 404 provide the power estimates, which can include a total average unit power and total standard deviation unit power for the associated circuit units, to an aggregator 420. The aggregator 420 can sum the total average unit power estimates to provide total chip average power P_{AVG}. The standard deviation of the average power consumption of the whole chip is related to the sum of the variances of the average powers of the units, which can be expressed, as follows:

$$chip {σ}_{0}^{2} = {\sum }_{i = 1}^{M} {τ}_{i}^{2} \qquad Eq . 52$$

where M is the number of testcases and τ is the standard deviation for each respective units.

Thus, the aggregator 420 can determine the total chip standard deviation from the unit power standard deviations provided by the respective power estimators 402 and 404. A total chip maximum power P_{MAX} can be determined as a function of the total chip standard deviation power (e.g., a three-sigma standard deviation power) and the total chip average power P_{AVG}.

For purposes of brevity, the power estimator 402 is depicted as including a model 422 and a power calculator 424. The model 422 can be implemented as any model, such as a statistical model, operative to estimate one or more power-related parameters (e.g., indicative of node-level switching activity) based on the functional verification information 406. Examples of model types that can be implemented are described herein. The model 422 updates the mean and standard deviation power estimates based on the functional verification information 406 provided over a plurality of respective testcases according to the statistical techniques being implemented. It is to be appreciated various types of models can be employed to represent beliefs about power-related circuit characteristics, which are not certain (or uncertain), but for which the power-related testcase information provided by the functional verification information 406 provides supporting evidence for infering estimates. As the number of testcases increases, the estimated mean or average value will eventually converge or saturate to a given level.

Each of the other M−1 power estimators 404 can be similarly configured to derive one or more power estimates for other circuit units. Thus, each power estimator 402, 404 can provide an estimated average power and standard deviation power for each functional or structural unit of the circuit design (e.g., a RTL model). The average power and estimated maximum power can then be aggregated by the aggregator 420. The estimated average and maximum power values for each functional unit further can be utilized to optimize the design process, such as in the case where one or more functional circuit units may consume an amount of power outside acceptable operating parameters. While distinct functional verification 410 and 412 has been depicted as being implemented on respective input vectors 414 and 416 for the respective power estimators 402 and 404, it is to be appreciated that common input vectors and functional verification can be used for all or a portion of the M power estimators 402-404.

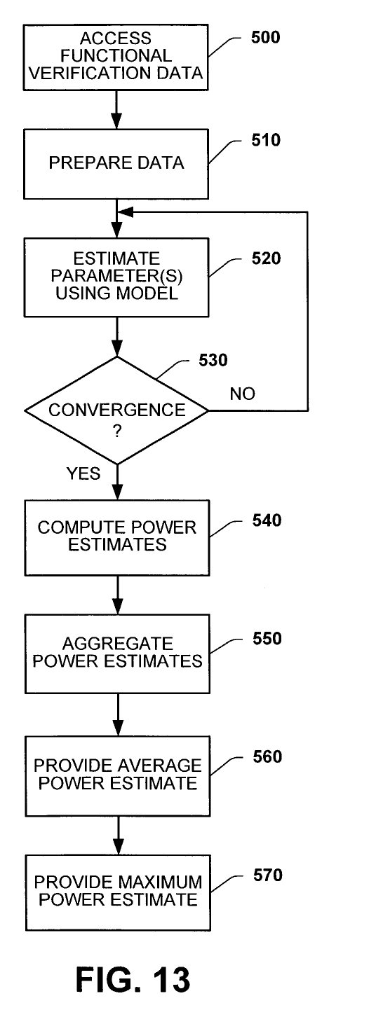

In view of the foregoing structural and functional features described above, a methodology for estimating power, in accordance with an aspect of the present invention, will be better appreciated with reference to FIG. 13. While, for purposes of simplicity of explanation, the methodology of FIG. 13 is shown and described as being implemented serially, it is to be understood and appreciated that the present invention is not limited to the illustrated order, as some aspects could, in accordance with the present invention, occur in different orders and/or concurrently with other aspects from that shown and described. Moreover, not all illustrated features may be required to implement a methodology in accordance with an aspect of the present invention. It is to be further understood that the following methodology can be implemented in hardware, software, or any combination thereof.

The methodology begins at 500 in which functional verification data is accessed, which can be located locally or remotely relative to where the methodology is being implemented. For example, the data includes power-related data derived from functional verification of a given circuit design or a selected portion thereof based on testcases that implement a plurality of input vectors. The circuit design can be defined by a circuit model, such as a RTL description or other type of circuit description. The model can be generated by any suitable CAD tool. The data provided at 500 can be generated by functional verification running in parallel and concurrently with the methodology of FIG. 13 or, alternatively, the functional verification data can be obtained from a database or other data structure that stores such data. By using functional verification data, no specific simulations or power-related input vectors need be developed, thereby reducing overhead typically associated with many conventional power estimation methods.

At 510, the functional verification data is prepared to facilitate subsequent analysis and computations. For example, the data preparation can include ascertaining power-related values for each functional verification testcase. Additionally, data can be prepared by sorting a number samples to mitigate fluctuations from the sample order. A moving average function also can be applied to the functional verification data, such as to facilitate convergence of the estimations to be determined. Other types of data preparation or data conversion can be utilized to facilitate power estimation. It is to be further appreciated that the data preparation implemented at 510 is optional, as subsequent portions of the methodology can be implemented in the absence of data preparation.

At 520, one or more power-related parameters are estimated using a statistical model. The power-related parameter, for example, can include switching activity characteristics, such as the activity factor data derived from the functional verification data provided at 500. The power-related parameters can include an indication of switching activities at any unit-level of an associated circuit design. In one particular example, the power-related parameter corresponds to the mean and standard deviation power for node-level switching characteristics, such as the activity factor. The granularity of such power-related parameters will depend on the type of circuit model and the particular circuit level description being utilized.

Additionally, those skilled in the art will understand and appreciate various types of statistical models that can be employed at 520 to estimate the parameters. A particular model can be selected according to the type of simulation implemented to provide the simulation data (at 500). For example, the statistical model can be implemented using moving average statistics. Alternatively, a Bayesian model could be utilized to estimate power-related parameters, which can be a simple Bayesian model or an asymptotic Bayesian model, as described herein. It is to be appreciated that these and other models that map to corresponding distribution functions can be efficiently employed to determine both mean and standard deviation power-related parameters concurrently using common functional verification testcases (see, e.g., Eq. 39), which can be utilized to further compute average and maximum power estimates, respectively, as described herein.

At 530, a determination is made as to whether the estimated parameters converge. The convergence can be determined based on substantially any convergence criteria. For example, convergence can be ascertained based on a subset of the most recent estimated parameters being within a predetermined threshold of each other. Alternatively, the parameters estimated at 520 can be fit to an asymptotic function that converges at a mean value for the respective parameter as the number of samples approaches infinity. The curve fitting, for example, can be implemented by employing least square estimates or other curve fitting techniques. If the determination at 530 indicates there is not adequate convergence, the methodology returns to 520 and statistical estimations are performed for additional testcases. If convergence has been achieved, however, the methodology proceeds to 540.

At 540, the power estimates are computed based on the model parameters estimated at 520. For the example where the estimated parameters corresponds to unit-level activity factors for the circuit design, mean unit power can be computed as a function of the estimated mean activity factor, C_{LOAD}, f_{CLK} and V_{DD} associated with respective units of the design. Additionally, a standard deviation power can also be computed based on the estimated mean power, which standard deviation corresponds to a maximum power estimate for each respective unit. In particular, maximum power for a given circuit unit corresponds to the unit mean power plus the standard deviation unit power for that circuit unit.

At 550, the power estimates at 540 are aggregated. For example, mean unit power estimates can be added together to provide a total average power estimate provided at 560 for the circuit design or a selected portion thereof. Additionally, the standard deviation unit power estimates can be added together to ascertain a total standard deviation power estimate (e.g., k-sigma standard deviation power, where k is an integer selected to provide a desired confidence level). The total power standard deviation is added to the total average power estimate provided at 560 to provide a total maximum power estimate at 570.

It is to be appreciated that the foregoing methodology at 500-570 can be repeated continually as additional functional verification testcases are run for a given circuit design. In this way, as simulations are run for a greater number of testcases, more accurate average and maximum power estimates provided at 560 and 570 can be achieved. Accordingly, the methodology is particularly effective for complex circuit designs, such as microprocessors, in which simulations (e.g., functional verification) are routinely and consistently implemented throughout various stages of the design process to ensure proper operation of the circuit and improve design convergence. Advantageously, the approach can provide good approximations of both average and maximum power based on a common set of testcases. Accordingly, by using functional verification results (already being generated for verifying functional operation), no specialized power simulation tool is required and it becomes unnecessary to design specific input vectors for power estimation.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A power estimation system, comprising:
functional verification data corresponding to functional behavior of at least one unit of a circuit design according to a testcase having a plurality of input vectors; and
a power estimator that determines an indication of power for the at least one unit of the circuit design based on the functional verification data generated over a plurality of testcases.

2. The system of claim 1, the power estimator determines an indication of average power and maximum power for the at least one unit of the circuit design, the average and maximum power being determined based on power-related information derived from the functional verification data generated over a plurality of testcases.

3. The system of claim 1, the power estimator further comprising a model that estimates at least one power-related parameter based on a switching activity factor derived from the functional verification data of each of the plurality of testcases.

4. The system of claim 3, the at least one power-related parameter comprising an estimated mean parameter and an estimated standard deviation parameter associated with a switching activity factor for the at least one unit of the circuit design.

5. The system of claim 4, the power estimator determines an indication of average power based on the estimated mean parameter for a plurality of respective units of the circuit design and determines an indication of maximum power based on the indication of average power and the estimated standard deviation parameter for the plurality of respective units of the circuit design.

6. The system of claim 1, further comprising an aggregator that aggregates an indication of mean unit power for the respective units of the circuit design to provide an indication of total average power for the respective units of the circuit design, and aggregates an indication of standard deviation unit power for the respective units of the circuit design to provide a total standard deviation power that is added to the indication of total average power to provide an indication of total maximum power for the respective units of the circuit design, the power estimator determining the indication of mean unit power for respective units of the circuit design and the indication of standard deviation unit power for the respective units of the circuit design.

7. The system of claim 1, the power estimator further comprising a plurality of power estimators, each of the plurality of power estimators being associated with a respective unit of the circuit design and operative to determine an indication of unit power for the associated respective unit of the circuit design based on the functional verification data generated for each respective unit over the plurality of testcases.

8. The system of claim 7, each of the plurality of power estimators comprising a model that estimates at least one power-related parameter based on the functional verification data generated for each respective unit over the plurality of testcases.

9. The system of claim 8, the at least one power-related parameter estimated by each model further comprising an estimated mean parameter and an estimated standard deviation parameter associated with a switching activity factor estimated for the associated respective unit of the circuit design.

10. The system of claim 7, further comprising an aggregator that aggregates the indication of unit power determined by the plurality of power estimators to provide an aggregate indication of power at least a portion of the circuit design.

11. A power estimation system, comprising:
a model that estimates at least one parameter indicative of power associated with at least one power consuming unit based on functional verification data generated by performing functional verification over a plurality of testcases, the functional verification data including power-related information for the plurality of testcases; and
a power calculator that computes estimated power based on the estimated at least one parameter.

12. The system of claim 11, the at least one parameter characterizing a power-related switching activity associated with the at least one unit of a given circuit design on which the functional verification is performed.

13. The system of claim 12, the at least one parameter characterizing a node-level activity factor, the model estimating the node-level activity factor for at least one respective node of the circuit design, the power calculator computing the estimated power based on the node-level activity factor estimated for the circuit design.

14. The system of claim 11, the functional verification data including switching activity information derived from functional verification of a circuit model that represents a circuit design on which the functional verification is performed, and a set of input vectors, which defines a testcase, being applied to exercise at least a portion of the circuit model and generate the functional verification data over the plurality of testcases.

15. The system of claim 14, the circuit model comprising a register transfer level model for at least a portion of the circuit design, the switching activity information characterizing node-level switching activities in the register transfer level model.

16. The system of claim 11, the power calculator computes the estimated power for a plurality of respective units of a circuit design based on the estimated at least one parameter and predetermined circuit-related data associated with the plurality of respective units of the circuit design.

17. The system of claim 16, the predetermined circuit-related data further comprising at least an indication of load capacitance for the plurality of respective units of the circuit design.

18. The system of claim 11, the power calculator computes a mean power estimate and a standard deviation power estimate for a plurality of respective units of a circuit design on which the functional verification is performed based on the estimated at least one parameter.

19. The system of claim 18, further comprising an aggregator that employs mean unit power estimates to provide an indication of a total estimated average power and employs standard deviation unit power estimates to provide a total estimated maximum power for that part of the circuit design represented by the plurality of respective units of the circuit design, the model determining the respective mean and standard deviation unit power estimates for the plurality of respective units of the circuit design.

20. The system of claim 18, the model determines estimated mean and standard deviation parameters for the plurality of respective units of the circuit design based on the functional verification data generated over the plurality of testcases, the power calculator computing mean power estimates based on the estimate mean parameters determined by the model and computing standard deviation power estimates based on the estimated standard deviation parameters determined by the model, common functional verification data being utilized by the model to determine both the mean and standard deviation estimates.

21. The system of claim 11, the model further comprising a statistical model that characterizes a belief about power-related characteristics for at least a portion of a circuit design on which the functional verification is performed, the estimated at least one parameter approximating a value for the power-related characteristic based on the functional verification data generated over the plurality of testcases.

22. The system of claim 21, the model further comprising one of a Bayesian model and moving average statistics operative to estimate at least one power-related parameter based on the functional verification data over the plurality of testcases.

23. The system of claim 21, further comprising a model evaluator that controls application of the model relative to the functional verification data based on a convergence criterion.

24. The system of claim 21, the statistical model further comprising a first estimator that determines an estimated mean parameter and a second estimator that that determines an estimated standard deviation parameter, an average power estimate for at least a portion of the circuit design being determined based on the estimated mean parameter and a maximum power estimate being determined based on the average power estimate and the estimated standard deviation parameter.

25. A power estimation system, comprising:
means for modeling at least one power-related parameter of a circuit design based on functional verification data over a plurality of testcases; and
means for computing a power estimate based at least in part on the modeled at least one parameter.

26. The power estimation system of claim 25, the means for modeling further comprising:
means for estimating a first power-related parameter based on functional verification data generated over a plurality of testcases; and
means for estimating a second power-related parameter based at least in part on the first power related parameter.

27. The power estimation system of claim 26, the means for computing further comprising:
means for computing a first power characteristic for the circuit design based on the first power related parameter and associated circuit-related data; and
means for computing a second power characteristic for the circuit design based on the first power characteristic and the estimated second power-related parameter.

28. The power estimation system of claim 25, further comprising:
unit means for modeling at least one power-related parameter for each associated one of a plurality of units of a circuit design based on functional verification data over the plurality of testcases; and
means for computing an aggregate power estimate for the associated plurality of units based at least in part on the at least one parameter modeled by the unit modeling means associated with each of the respective plurality of units.

29. The power estimation system of claim 25, further comprising means for providing the functional verification data based on a set of input vectors applied to exercise at least a portion of the circuit design, each of the plurality of testcases including a respective set of input vectors.

30. A power estimation method for a circuit design, comprising:
accessing functional verification data generated for the circuit design based on a set of input vectors that defines a testcase; and
estimating an indication of power for at least one unit of the circuit based on the functional verification data generated over a plurality of testcases.

31. The method of claim 30, the estimation further comprising estimating an indication of unit power for each of a plurality of respective units of the circuit design, the respective indications of unit power being aggregated to provide an aggregate indication of power for that portion of the circuit design associated with the plurality of respective units.

32. The method of claim 30, the accessing further comprising at least one of obtaining the functional verification data from memory and receiving the functional verification data from a simulation being implemented in parallel with the power estimation method.

33. The method of claim 30, further comprising:
employing a model to characterize at least one parameter related to power consumption based on the functional verification data;
applying the functional verification data over a plurality of testcases to update the at least one parameter characterized by the model; and
the estimation of the indication of power being based on the updated at least one parameter.

34. The method of claim 33, the at least one parameter related to power comprising a mean estimate and a standard deviation estimate of a switching activity factor for at least one unit of the circuit design.

35. The method of claim 34, further comprising controlling the estimation of the indication of power to facilitate convergence of the indication of power being estimated.

36. A computer-readable medium having computer-executable instructions for performing the method of claim 30.
